(19) United States
(12) Patent Application Publication
(10) Pub. No.: US 2005/0220255 A1
(43) Pub. Date: Oct. 6, 2005

(54) Storage device provided to be placed in a packaging intended for the transport of radioactive materials

(76) Inventors: Yann Hermouet, Guy An Court (FR); Alexandre Biguet, Neuilly Plaisance (FR)

Correspondence Address: Robert E. Krebs;Thelen Reid & Priest LLP, P.O. Box 640640, San Jose, CA, 95164-0640, US

(21) Appl. No.: 11/040,837

(22) Filed: Jan. 21, 2005

(30) Foreign Application Priority Data
Jan. 23, 2004 (FR) 04 50122

(51) Int. Cl. G21C 19/00

(52) U.S. Cl. 376/272

(57) ABSTRACT

The invention relates to a storage device provided to be placed in a packaging intended for the transport of radioactive materials, comprising a plurality of housings (2) at least one of which has a lateral wall formed in part by means of a wall element in stainless steel (10) assembled to a wall element in aluminium or in one of its alloys (6) through the intermediary of at least one assembly system (24) comprising a stainless steel screw (28) going through the wall element (10) and lying in abutment against it. According to the invention, the system (24) further comprises a stainless steel sprocket wheel (52) arranged in a sprocket wheel housing (42) provided in the wall element (6) and communicating with a passage (48) crossed by the screw (28), the sprocket wheel (52) having a threaded hole (56) cooperating with said screw (28).

### TECHNICAL FIELD

The present invention relates to, in a general manner, a storage device provided to be placed in a packaging intended for the transport of radioactive materials, such as for example nuclear fuel assemblies that have been previously irradiated in a nuclear reactor.

### STATE OF THE PRIOR ART

Such storage devices, also know as storage “baskets” or “racks”, have a plurality of housings within which may be placed irradiated nuclear fuel assemblies, with a view to being transported.

In the nuclear industry, fuel assemblies constitute the energy source of nuclear power plants, and consequently have to be stored and/or moved during a time period extending from the end of their use as an energy source for the power plant, and their storage in reprocessing sites.

Indeed, the storage devices find an application for the transport of said irradiated fuel assemblies, for example between the nuclear power plants and the reprocessing sites.

Storage devices of this type must meet various functions. In particular, these functions comprise the mechanical resistance and the cushioning of the radioactive materials, as well as the ability to be handled.

Moreover, depending on the nature of the radioactive materials, the storage device has to assure various functions linked to the nuclear safety of the transport or the storage. Among these functions, one may cite in particular the necessity to evacuate the flow of heat produced by the materials contained in the device and the control of the nuclear criticality, when said materials are fissile materials capable of causing a chain reaction.

The purpose of the mechanical resistance function is to maintain the geometry of the device during handling operations, under the effect of accelerations encountered during transport, but also in the event of impact or accidental dropping, in order to control the nuclear criticality under such circumstances. Moreover, it is worth pointing out that these configurations are subject to regulatory tests.

Nuclear full assembly storage devices normally have a plurality of adjacent housings, each with a square or hexagonal cross section, in order to allow a fuel assembly of complementary shape to be introduced and maintained within said housing.

From the prior art it is known and advantageous to form a central structure of the storage device by means of wall elements assembled between each other and made out of alloy of aluminium and boron, this material being selected due to its capacity to absorb the neutrons, and consequently to assure the control of the nuclear safety. It should be noted that this central structure makes it possible to entirely constitute the lateral wall of the central housing(s) of the device, but to only partially constitute the lateral wall of the peripheral housings, which remain open laterally towards the exterior of said device.

Thus, a plurality of peripheral wall elements arranged around and in contact with the central structure is also provided. These peripheral wall elements, advantageously made out of stainless steel, then participate in constituting the lateral wall of the peripheral housings of the device, jointly with the central structure.

In other words, each housing of the central structure is formed by the intermediary of a plurality of wall elements that, when they are assembled, form the lateral wall of the housing.

The reason for the preferred use of stainless steel to form these peripheral wall elements is that this material provides additional gamma shielding, and also by the fact that it is capable of conferring rigidity to the storage device.

It is worth pointing out in this respect that the characteristic of high rigidity of the device is with all the more reason beneficial in that it allows the storage device to meet the regulatory safety requirements for the transport/storage of the above mentioned nuclear fuel assemblies.

Moreover, the combined use of wall elements in aluminium and boron alloy and of wall elements in stainless steel easily allows the storage device to be compatible with the requirement of a maximum weight to be complied with, this mass limitation being imposed by the operational constraints.

Nevertheless, despite the above mentioned advantages with regard to this type of configuration, this type of storage device has major disadvantages. Indeed, stainless steel assembly screws are used to assure the fastening between the wall elements of the central structure, and the peripheral wall elements in contact with said wall elements of the central structure.

Thus, it is evident that a stainless steel screw screwed into the aluminium alloy of a wall element of the central structure does not allow an important prestress to be applied, in so far as such a prestress would ineluctably lead to damage to the thread of the aluminium alloy. Consequently, the absence of high intensity tightening weakens, in a notable manner, the overall rigidity of the storage device.

In an even more limiting manner, it should be noted that the storage device is subjected to a high number of thermal cycles of considerable amplitude, said thermal cycles then generating a phenomenon of consequent differential dilation between the various wall elements, and also between the stainless steel screws and the peripheral wall elements in aluminium alloy.

Effectively, at high temperatures, the much more pronounced dilation of the aluminium alloy has the consequence of reducing the contact surface between the thread of the stainless steel and the aluminium alloy thread of the threaded hole provided in the wall element in question, in such a way that the mechanical link procured by the screw is considerably weakened or even totally broken when the thermal dilation is such that there is no more contact between the two threads in question.

Obviously, the loss of the mechanical link that occurs with regard to one or several assembly screws may also lead to a partial or total rupture of contact between the two wall elements involved. In this case, the thermal transfer between these two elements naturally cannot be assured in a satisfactory manner.

Finally, it is pointed out that another disadvantage with regard to the presence of such an assembly resides in the fact that during high thermal stresses, the thread in aluminium and boron alloy becomes relatively soft, and is therefore capable of deforming and rapidly deteriorating on contact with the stainless steel screw, which for its part is rigid.

### OBJECT OF THE INVENTION

The aim of the invention is therefore to propose a storage device provided to be placed in a packaging intended for the transport of radioactive materials, the device comprising a plurality of housings each extending along a longitudinal axis and at least one of which has a lateral wall formed at least in part by means of a wall element in stainless steel assembled to a wall element in aluminium or in one of its alloys, said device remedying at least partially the above mentioned disadvantages relating to the realisations of the prior art.

More precisely, the aim of the present invention is a storage device in which the assembly system(s), provided to assure the fastening of a wall element in stainless steel to a wall element in aluminium or in one of its alloys, are capable of withstanding the harmful effects that may be provoked by the phenomenon of differential dilation.

To achieve this, the object of the invention is a storage device provided to be placed in a packaging intended for the transport of radioactive materials, said device comprising a plurality of housings each extending along a longitudinal axis and at least one of which has a lateral wall formed, at least in part, by means of a wall element in stainless steel assembled to a wall element in aluminium or in one of its alloys by the intermediary of at least one assembly system comprising a stainless steel screw going through said stainless steel wall element and lying in abutment against it. According to the invention, the assembly system further comprises a stainless steel sprocket wheel arranged in a sprocket wheel housing provided in the wall element in aluminium or in one of its alloys and communicating with a passage through which the screw passes, the sprocket wheel having a threaded hole cooperating with this stainless steel screw.

Advantageously, the proposed assembly system(s) each comprise principally a stainless steel screw screwed in a sprocket wheel formed in the same material, in such a way that these two elements do not undergo differential dilation, nor the harmful effects linked to this phenomenon. Thus, the mechanical link(s), respectively assured by the assembly system (provided between a wall element in stainless steel and a wall element in aluminium or in one of its alloys), remain intact even when the storage device according to the invention is subjected to high temperatures.

Furthermore, it is pointed out that during high thermal stresses, the mechanical links procured by the assembly systems are even reinforced. In fact, all in all, this is explained by the fact that the portion of the wall element in aluminium or in one of its alloys, located between the wall element in stainless steel and the sprocket wheel formed in an identical material, has a tendency to dilate and consequently to constrain even further the above mentioned assembly system.

In this respect, it is also pointed out that the specific material used to manufacture the screw and the sprocket wheel makes it possible to apply extremely high prestresses and thus to give a storage device of very high overall rigidity.

Preferably, the screw in stainless steel goes through an oblong hole provided in the wall element in stainless steel, said oblong hole having two parallel faces arranged substantially parallel to the longitudinal axis of the housing. Thus, the screw of the assembly system may move within said oblong hole, in such a way that the specific arrangement proposed allows a relative movement between the two wall elements along the longitudinal axis of the housing concerned, during heavy thermal stresses leading to a differential dilation between these two elements.

Preferentially, the assembly system comprises an anti-rotation washer interposed between a screw head in stainless steel and said wall element in stainless steel, and/or a dilation washer also interposed between said screw head and the wall element in stainless steel.

In order to obtain a good positioning of the sprocket wheel within the sprocket wheel housing, and to assure that the threaded hole of the sprocket wheel is indeed located opposite and in the continuation of the passage of the wall element in aluminium or in one of its alloys, it is possible to provide that this sprocket wheel comprises a protuberance cooperating with a notch formed in the sprocket wheel housing. Naturally, it would also have been possible to provide a sprocket wheel whose shape imposes a unique and adequate positioning within the sprocket wheel housing of complementary shape, without going beyond the scope of the invention.

Preferably, the sprocket wheel is a cylinder of section in the form of a disc and with an axis perpendicular to an axis of the screw in stainless steel.

Furthermore, the device may comprise a central structure formed by means of a plurality of wall elements in aluminium or in one of its alloys, the central structure constitutes in particular, in a partial manner, the lateral wall of a plurality of peripheral housings. Moreover, the lateral wall of the peripheral housings is also constituted by peripheral wall elements in stainless steel.

In this case, it is also preferred to provide that a plurality of assembly systems is provided between each assembly formed by a wall element in aluminium or in one of its alloys, and a peripheral wall element in stainless steel in contact with it.

Other advantages and characteristics of the invention will become clear on reading the following detailed but non limitative description.

### BRIEF DESCRIPTION OF DRAWINGS

This description will be made with regard to the appended drawings, in which;

FIG. 1 represents a partially exploded perspective view of part of a storage device according to a preferred embodiment of the present invention; and

FIG. 2 represents an enlarged and exploded perspective view of a part of the storage device of FIG. 1, showing, in a detailed manner, an assembly system equipping an assembly formed by a wall element in aluminium or in one of its alloys, and a peripheral wall element in stainless steel in contact with it.

### DETAILED DESCRIPTION OF PREFERRED EMBODIMENTS

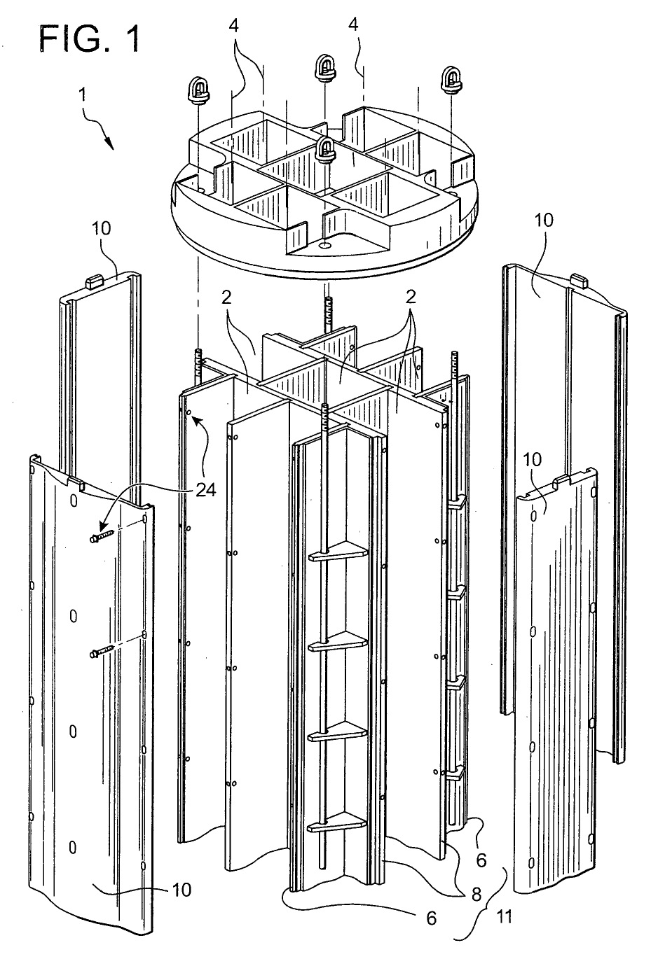

FIG. 1 represents a storage device 1 provided to be placed in a packaging (not represented) intended for the transport of radioactive materials, such as for example nuclear fuel assemblies (not represented), according to a preferred embodiment of the present invention.

As can be seen in FIG. 1, the storage device 1 comprises a plurality of housings 2 arranged in parallel, said housings 2 each extending along a longitudinal axis 4. The housings 2 are each capable of receiving at least one square section fuel assembly, preferably a single fuel assembly.

The housings 2 are provided in such a way as to be juxtaposed to each other. They are formed by the intermediary of a plurality of wall elements 6, 8 and 10, certain of which are shared by several housings 2 of the device 1. Moreover, in this preferred embodiment, said wall elements 6, 8 and 10 each takes, roughly speaking, the shape of a plate. When they are assembled, the wall elements 6, 8 and 10 form the lateral wall of each of the housings 2, said lateral wall preferably having a cross section of substantially square shape, but which could also adopt other shapes that enable a fuel assembly of a different shape, such as a hexagonal shape, to be maintained.

In order to allow each housing 2 to have a cross section of substantially square shape, four wall elements 6, 8 and 10 are assembly between each other in such a way as to be arranged parallel and perpendicular to each other. In this respect, one notes that the wall elements 6, 8 and 10 are broken down into three distinct sets of elements, respectively defined by a first set of wall elements, a second set of wall elements, and a set of peripheral wall elements.

Still referring to FIG. 1, one sees the assembly between the wall elements 6 of the first set of wall elements, and the wall elements 8 of the second set of wall elements. The elements 6 are arranged parallel to each other, in the same way as the elements 8 between each other. Moreover, the wall elements 6 are assembled in such a way as to be substantially perpendicular to the wall elements 8.

It should be noted, as can be seen in FIG. 1, that in this preferred embodiment, the wall elements 6 and 8 each extends over the whole length of the housing(s) 2 that they form, in such a way that each of them constitutes one of the four flat lateral faces of the wall of one or several housings 2.

In the preferred embodiment described, the storage device 1 comprises seven housings 2, arranged in such a way that each of the two wall elements 8 or each of two stacks of wall elements 8 partially fine the lateral wall of three housings 2 by means of one of its faces, as well as the lateral wall of two housings 2 by means of the other of its faces. Moreover, it is pointed out that the faces of elements 8 or the stacks of elements 8, partially defining the lateral wall of three housings 2, are positioned opposite each other, in such a way that the two elements 8 or the two stacks of elements 8 belong to the lateral wall of the same three housings 2.

Furthermore, it should be noted that the wall elements 6 and 8 in aluminium and boron alloy jointly form a central structure 11 of the device 1, said central structure 11 constituting on the one hand the whole of the lateral wall of a unique central housing 2, and secondly a part of the lateral wall of six peripheral housings 2. In other words, as can be clearly seen in FIG. 1, the wall elements 6 and 8 of the principal structure 11 forming uniquely three of the four lateral faces of the lateral wall of the six peripheral housings 2 surrounding the central housing 2, the missing lateral face being the one that makes it possible to isolate the peripheral housings 2 with regard to the exterior.

Each of the wall elements 6 of the first set of wall elements is assembled on at least one of the wall elements 8 of the second set of wall elements.

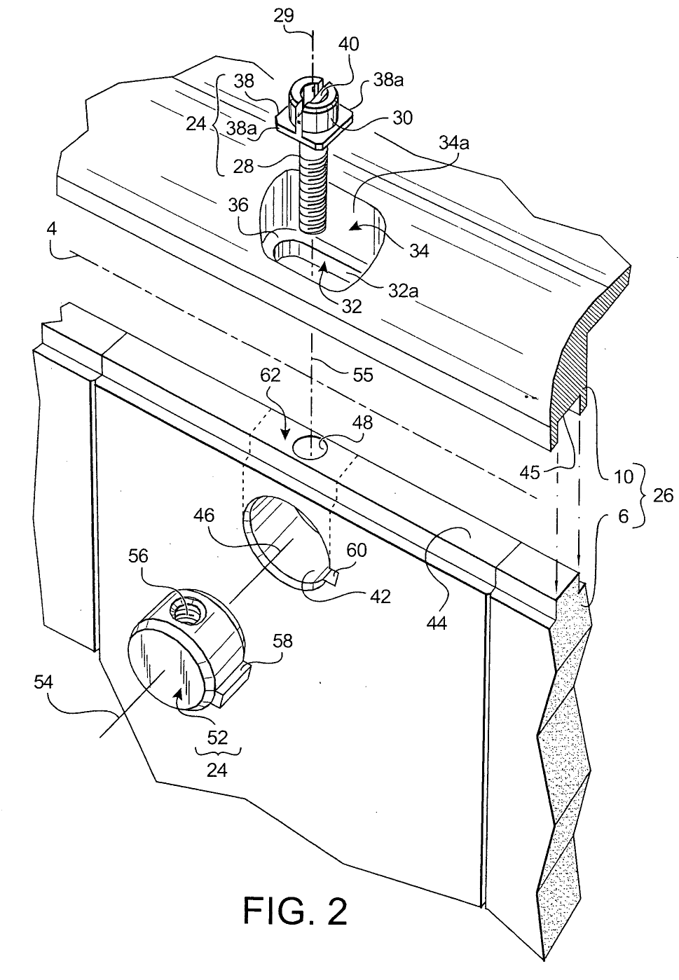

Furthermore, the wall elements 10 of the set of peripheral wall elements of the storage device 1, made out of stainless steel, are fastened to the wall elements 6 and 8, in such a way as to constitute the missing lateral face of the lateral wall of the six peripheral housings 6. As an illustrative example, one may provide four wall elements 10 in stainless steel, two of which each assure the closing of two peripheral adjacent housings 2. In this respect, the fastening between any wall element 10 in stainless steel and any wall element 6, 8 in aluminium and boron alloy in contact with said any element 10, is formed by means of a plurality of assembly systems 24, for example spaced along a direction parallel to the longitudinal axis 4 of the associated housing 2. These assembly systems 24 constitute the specific feature of the present invention. Consequently, one of them will be described in a detailed manner hereafter, in reference to FIG. 2.

Now, with reference to FIG. 2, one can see an assembly 26 formed by a wall element 6 in aluminium and boron alloy, and a peripheral wall element 10 in stainless steel intended to be assembled and in contact with said element 6. The elements 6 and 10, arranged perpendicularly, are fastened to each other by the intermediary of a plurality of assembly systems 24 (only one being shown in this FIG. 2). Obviously, it is understood that any assembly of FIG. 1, comprising a wall element 6, 8 assembled and in contact with a wall element 10, may be assimilated to the assembly 26, for which one of the associated assembly systems 24 will now be detailed.

The assembly system 24 firstly comprises a stainless steel screw 28, the head 30 of which is lying in abutment against the wall element 10. More precisely, the screw 28, arranged substantially perpendicular to the wall element 10, goes through an oblong hole 32 formed in the bulk of said element 10. The oblong hole 32 has two parallel faces 32a arranged on the one hand substantially parallel to the longitudinal axis 4 of the housing 2 formed, in particular, by the elements 6 and 10 represented and, on the other hand, substantially perpendicular to an imaginary plane (not represented), defined by the wall element 10.

Another oblong hole 34 is also formed in a part of the bulk of the wall element 10, in a superimposed manner to the oblong hole 32, and obviously in such a way that is has a length and a width bigger than those of the oblong hole 32. Furthermore, this oblong hole 34 thus has two parallel faces 34a arranged substantially parallel to the faces 32a of the hole 32, and in which the distance separating them is greater than the distance separating these same two faces 32a. In this respect, it is pointed out that the distance separating the two parallel faces 34a is preferably greater to a diameter of the head 30 of the screw 28.

Consequently, as can be clearly seen in FIG. 2, the superposition of two oblong holes 32, 34 reveals a shoulder surface 36 that takes, roughly speaking, the shape of two identical parallel strips connected at their ends by two half-rings, this surface 36 being parallel to the above mentioned imaginary plane. Thus, it is on this shoulder surface 36 that the head 30 of the screw 28 in stainless steel rests against.

More precisely, it is an anti-rotation washer 38 of the system 24, arranged in abutment under the head of the screw 30, which rests against the shoulder surface 36 of the wall element 10. As can be seen in FIG. 2, this anti-rotation washer 38 has, roughly speaking, a square shape provided so that two opposing sides 38a of this square respectively hug the two parallel faces 34a of the oblong hole 34. In this way, the washer 38 cannot turn in relation to the wall element 10. Furthermore, the anti-rotation washer 38 is also provided with a tongue 40 integral with any side of the square which, once bent as represented in FIG. 2, may lie in a slot (not referenced) provided in the screw head 30. In this way, the screw 28 cannot pivot in relation to the washer 38 and, consequently, can no longer turn in relation to the wall element 10.

By way of indication, one or several expansion washers (not represented) could also have been placed between the screw head 30 and the shoulder surface 36, without going beyond the scope of the invention.

Moreover, a sprocket wheel housing 42 is formed in the wall element 6, near to a longitudinal edge 44 of said element 6, said longitudinal edge 44 being that intended to come into contact with the wall element 10 in stainless steel. In this respect, it is pointed out that the edge 44 may have a complementary shape to that of a slot 45 provided in the wall element 10, in such a way as to reinforce the fastening between these elements 6 and 10.

The sprocket wheel housing 42, formed in the bulk of the wall element 6, may equally well be opening out or crossing through, and have for example a cylindrical shape of circular section with axis 46, perpendicular to a screw axis 29. Moreover, a passage 48 formed in the wall element 6 opens out on the one hand at the level of the longitudinal edge 44, and secondly within the sprocket wheel housing 42. Thus, it is preferably provided that this passage 48 is cylindrical, of circular section, with a diameter less than that of the section of the sprocket wheel housing 42, and also that this passage 48 has an axis 50 that intersects and is perpendicular to the axis 46 of this sprocket wheel housing 42.

The assembly system 24 then has a sprocket wheel 52 in stainless steel, preferably of shape complementary to that of the sprocket wheel housing 42, said sprocket wheel 52 being inserted within said housing 42. Consequently, the sprocket wheel 52 takes the form of a cylinder of section in the form of a disc, with an axis 54 confused with the axis 46 of the housing 42.

The sprocket wheel 52 has a threaded hole 56 receiving the stainless steel screw 28, said threaded hole 56 being equally well opening out, and for example oriented along a diameter of the sprocket wheel 52 of cylindrical shape. Naturally, the sprocket wheel 52 is positioned within the sprocket wheel housing 42 in such a way that the threaded hole 56 is located opposite and in the continuation of the passage 48, as represented in FIG. 2. In this way, the screw 28 can go through the passage 48 of larger diameter, and be threaded in the threaded hole 56.

To assure that such an angular positioning of the sprocket wheel 52 is obtained, it is possible to provide a protuberance 58 on the sprocket wheel 52, as well as a slot 60, preferably of complementary shape, in the sprocket wheel housing 42.

Consequently, with the arrangement that has been described above, it can be seen that the screw 28 and the sprocket wheel 52 made out of stainless steel do not undergo differential dilation, in such a way that the mechanical link that they procure remains intact, even when the storage device 1 is subjected to high temperatures.

Furthermore, during high thermal stresses, the mechanical link procured by the assembly system 24 is even reinforced, since a portion 62 of the wall element 6 (demarcated by a dotted line in FIG. 2), situated between the wall element 10 and the sprocket wheel 52, has a tendency to dilate and, consequently, further constrain the screw/sprocket wheel system 28, 52.

Finally, it is pointed out that the oblong holes 32 and 34 provided in the wall element 10 allow the screw 28 to move along the direction parallel to the longitudinal axis 4 of the housing 2, in such a way as to withstand the differential dilation capable of being observed between two wall elements 6 and 10 made out of different materials.

Obviously, various modifications may be made by those skilled in the art to the storage device 1 that has just been described, uniquely by way of example and in nowise limitative.

1. Storage device (1) provided to be placed in a packaging intended for the transport of radioactive materials, said device comprising a plurality of housings (2) each extending along a longitudinal axis (4) and at least one of which has a lateral wall formed at least in part by means of a wall element in stainless steel (10) assembled to a wall element in aluminium or in one of its alloys (6,8) by the intermediary of at least one assembly system (24) comprising a stainless steel screw (28) crossing through said wall element in stainless steel (10) and lying in abutment against it, characterised in that said assembly system (24) further comprises a stainless steel sprocket wheel (52) arranged in a sprocket wheel housing (42) provided in said wall element in aluminium or in one of its alloys (6,8) and communicating with a passage (48) crossed through by said screw (28), said sprocket wheel (52) having a threaded hole (56) cooperating with said stainless steel screw (28).

2. Storage device (1) according to claim 1, characterised in that the stainless steel screw (28) goes through an oblong hole (32) provided in said wall element in stainless steel (10), the oblong hole (32) having two parallel faces (32a) arranged substantially parallel to the longitudinal axis (4) of the housing (2).

3. Storage device (1) according to claim 1, characterised in that said assembly system (24) further comprises an anti-rotation washer (38) interposed between a head (30) of the screw in stainless steel (28) and said wall element in stainless steel (10).

4. Storage device (1) according to claim 1, characterised in that said assembly system (24) further comprises a dilation washer interposed between a head (30) of the screw in stainless steel (28) and said wall element in stainless steel (10).

5. Storage device (1) according to claim 1, characterised in that said sprocket wheel (52) comprises a protuberance (58) cooperating with a notch (60) formed in the sprocket wheel housing (42).

6. Storage device (1) according to claim 1, characterised in that said sprocket wheel (52) is a cylinder of section in disc shape, and of axis (54) perpendicular to an axis (29) of said stainless steel screw (28).

7. Storage device (1) according to claim 1, further comprising a central structure (11) formed by means of a plurality of wall elements in aluminium or in one of its alloys (6,8), said central structure (11) constituting in particular, in a partial manner, the lateral wall of a plurality of peripheral housings (2), and in that the lateral wall of said peripheral housings (2) is also constituted by peripheral wall elements in stainless steel (10).

8. Storage device (1) according to claim 7, characterised in that a plurality of assembly systems (24) is provided between each assembly (26) formed by a wall element in aluminium or in one of its alloys (6,8), and a peripheral wall element in stainless steel (10) in contact with it.

9. Storage device (1) according to claim 1, characterised in that each wall element in aluminium or in one of its alloys (6,8) is formed in an alloy of aluminium and boron.
